(19) United States
(12) Patent Application Publication
(10) Pub. No.: US 2020/0017269 A1
(43) Pub. Date: Jan. 16, 2020

(54) Flexible Reinforcement for Flexible Container

(71) Applicant: Printpack Illinois, Inc., Elgin, IL (US)

(72) Inventors: Louis R. Duckwall, JR., Marietta, GA (US); William Faulkner, Marietta, GA (US)

(21) Appl. No.: 16/505,759

(22) Filed: Jul. 9, 2019

Related U.S. Application Data
(60) Provisional application No. 62/696,493, filed on Jul. 11, 2018.

(51) Int. Cl. B65D 75/52; B32B 27/08; B65D 83/00; B65D 81/02

(52) U.S. Cl. CPC B65D 75/525; B32B 27/08; B32B 2439/46; B65D 81/025; B32B 2307/516; B65D 83/0055

(57) ABSTRACT

A package includes a polymeric flexible bag with an opening to an interior space configured to contain liquid, and a flexible reinforcing article having a cavity at least partially containing the flexible bag. The reinforcing article protects the flexible bag from impacts. The reinforcing article includes at least one piece of flexible polymeric material extending at least partially around the cavity. The reinforcing article circumferentially engages, and circumferentially provides inwardly oriented force against, an exterior of the flexible bag. Opposite ends of the reinforcing article are spaced apart by a distance that is less than a distance between opposite ends of the flexible bag. An opening of the reinforcing article is proximate one of the opposite ends of the reinforcing article and configured to have a portion of the flexible bag extend through the opening. The reinforcing article can be a sleeve or bag.

### CROSS-REFERENCE TO PRIORITY APPLICATION

This U.S. nonprovisional application claims the benefit of U.S. Patent Application Ser. No. 62/696,493 for Flexible Reinforcement for Flexible Container, (filed Jul. 11, 2018) which is hereby incorporated by reference in its entirety.

### BACKGROUND

Flexible polymeric containers for holding liquid are known. Some of such polymeric containers include fitments for filling and/or dispensing the liquid. For example, flexible polymeric containers including fitments can be used for holding beverage concentrates. Examples of such flexible polymeric containers are disclosed in U.S. Pat. Nos. 8,231,029, 8,348,509, 8,840,305, and 9,908,668.

After being filled with liquid, some flexible polymeric containers are prone to bursting if dropped. Therefore, each of the liquid-filled containers is often deposited in a respective cardboard box. Placing such a liquid-filled container into a cardboard box provides structure and stability to the container to facilitate handling, storage, and stacking. This “bag in box” combination typically requires that the liquid-filled container be formed from a relatively thick polymer film (e.g., at least 10 gauge) to provide the necessary degree of strength and impact resistance.

There may be disadvantages associated with placing each of such liquid-filled containers into a respective cardboard box. As one possible example, in order to facilitate recycling it may be necessary to remove (e.g., manually remove) the emptied container from its cardboard box. Thus, there remains a need for improved flexible containers and/or means of storing, handling, and/or reinforcing such containers.

### SUMMARY

An aspect of this disclosure is the provision of a package including a polymeric flexible bag with an opening to an interior space containing liquid, and a polymeric flexible reinforcing article having a cavity at least partially containing the flexible bag. In at least one embodiment of this disclosure, the reinforcing article is configured to at least partially protect the flexible bag from impacts. For example, the reinforcing article can be configured to circumferentially engage, and circumferentially provide inwardly oriented force against, an exterior of the flexible bag.

Opposite ends of the reinforcing article are typically spaced apart by a distance that is less than a distance between opposite ends of the flexible bag. An opening of the reinforcing article can be positioned proximate one of the opposite ends of the reinforcing article and be configured to have a portion of the flexible bag extend through the opening. The package typically includes a fitment mounted to the opening of the flexible bag, wherein the fitment and/or one or more associated components can be configured for selectively closing the opening of the flexible bag.

In one example, a portion of the flexible bag that includes the fitment and a handle of the flexible bag extends upwardly through the opening of the reinforcing article so that the fitment and handle are positioned outside of the reinforcing article. The reinforcing article can be an outer bag that is shorter than the inner flexible bag.

In another example, the reinforcing article can be a sleeve. A portion of the flexible bag that includes the fitment and a handle of the flexible bag can extend outwardly through one end of the sleeve, and a portion of the flexible bag that includes another handle of the flexible bag can extend outwardly through the other end of the sleeve.

The foregoing summary provides a few brief examples and is not exhaustive, and the present invention is not limited to the foregoing examples. The foregoing examples, as well as other examples, are further explained in the following detailed description with reference to accompanying drawings.

### BRIEF DESCRIPTION OF THE DRAWINGS

The drawings are provided as examples. The present invention may be embodied in many different forms and should not be construed as limited to the examples depicted in the drawings. The drawings may be schematic and may not be drawn to scale.

FIG. 1 is a partially exploded, front-left, bottom perspective view of package of a first embodiment of this disclosure, wherein the package includes a conventional, flexible polymeric container (e.g., bag) and a bag-shaped hollow body or article for reinforcing the conventional container, the interior of the conventional container is substantially full of liquid, and a portion of the reinforcing article is cut away to show the interior and opening of the reinforcing article.

FIG. 2 is a front-right perspective view of the assembled package of FIG. 1.

FIG. 3 is a right-rear perspective view of the package of FIG. 2.

FIG. 4 is an isolated, schematic, exploded view of a representative portion of the material from which the bag-shaped reinforcing article of FIG. 1 is constructed, in accordance with a first version of the first embodiment.

FIG. 5 is an isolated, schematic, exploded view of a representative portion of the material from which the bag-shaped reinforcing article of FIG. 1 is constructed, in accordance with a second version of the first embodiment.

FIG. 6 is a perspective view of the conventional container of FIG. 1 partially contained by a sleeve-shaped hollow body or article for reinforcing the conventional container, wherein the interior of the conventional container is substantially full of liquid, in accordance with a second embodiment of this disclosure.

FIG. 7 depicts a flexible sheet or strip of material that is in a flat configuration and can be formed into the sleeve-shaped reinforcing article, in accordance with the second embodiment.

FIG. 8 is an isolated perspective view of the sleeve-shaped reinforcing article of FIG. 6 in accordance with a first version of the second embodiment.

FIG. 9 is an isolated, schematic, perspective view of a sleeve-shaped reinforcing article in accordance with a second version of the second embodiment.

### DETAILED DESCRIPTION

Examples of embodiments are disclosed in the following. The present invention may, however, be embodied in many different forms and should not be construed as limited to the embodiments set forth herein. For example, features disclosed as part of one embodiment can be used in the context of another embodiment to yield a further embodiment. As another example of the breadth of this disclosure, it is within the scope of this disclosure for one or more of the terms “substantially,” “about,” “approximately,” and/or the like, to qualify each of the adjectives and adverbs of the Detailed Description section of disclosure, as discussed in greater detail below.

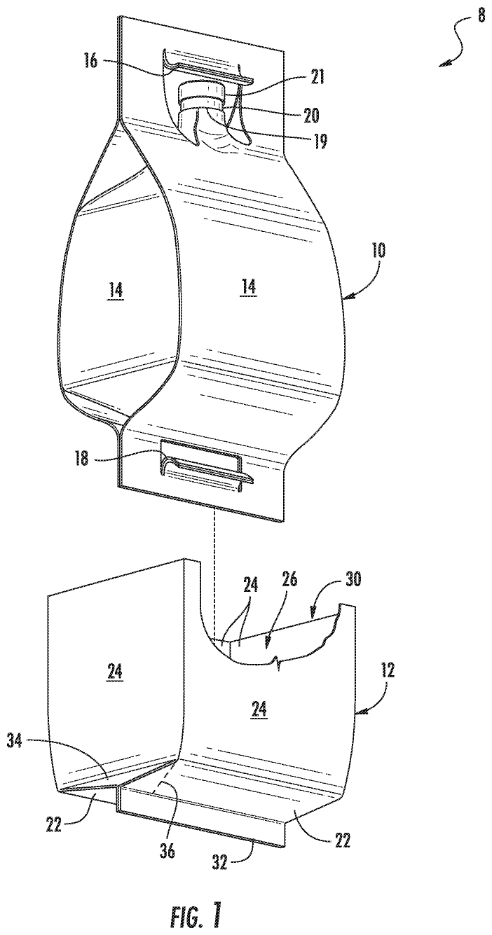

FIG. 1 depicts a package 8 including a bag-shaped reinforcing article 12 and a conventional, flexible polymeric container 10 (e.g., “conventional bag”) containing liquid. In FIG. 1, the conventional container 10 is depicted in its substantially fully-filled configuration, and as being exploded away from the bag-shaped reinforcing article 12 that is configured to partially or at least partially contain the conventional container. It is believed that U.S. Pat. Nos. 8,231,029, 8,348,509, 8,840,305, and 9,908,668 disclose suitable examples of the conventional bag 10 and associated, fitments, caps, and/or the like.

The depicted example of the conventional bag 10 can be formed from one or more panels of flexible polymeric film that are connected to one another at respective seams, so that the conventional bag 10 includes one or more sidewalls 14 extending between upper and lower portions of the conventional bag, and the sidewall(s) extend around an interior of the conventional bag. The upper and lower portions of the conventional bag 10 respectively include upper and lower handles 16, 18.

In the example depicted in the drawings, the upper portion of the conventional bag 10 includes a somewhat or generally cylindrical, sleeve-like opening 19 to the interior of the conventional bag; a tubular fitment 20 is mounted in, and extends outwardly from, the bag opening 19; and a removable cap 21 is mounted to the outer end portion of the fitment 20 for opening and closing access to the interior of the conventional bag. The fitment 20 and cap 21 are typically rigid articles that are molded from polymeric material. An annular portion of the outer surface of the fitment 20 can be positioned in the bag opening 19, and the portion of the fitment in the bag opening can be circumferentially sealed and/or welded to the bag opening in a conventional manner to form a leak-proof seal therebetween. External threads of the fitment 20 can mate with internal threads of the cap 21 for providing the openable, leak-proof connection therebetween. As examples, the fitment 20 can include a valve (e.g., a one-way valve), the cap 21 and/or fitment 20 can be replaced with a conventional spigot having a valve actuated by a handle or lever, or access to the contents in the interior of the conventional bag 10 may be provided in any other suitable manner. As more general examples, the fitment 20, cap 21, and/or any associated valves, spigots, or the like, can be a variety of differently configured conventional items that may be conventionally mounted to the bag opening 19.

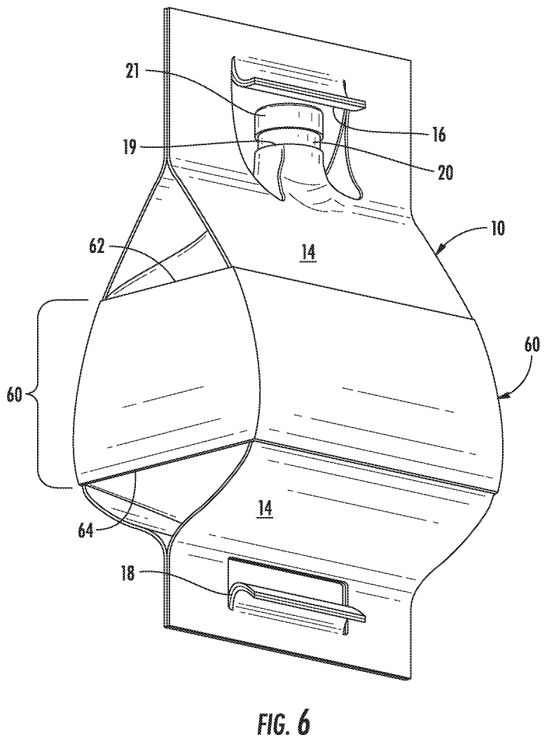

An aspect of this disclosure is the provision of hollow bodies or other suitable articles for at least partially containing and reinforcing conventional bags 10. Accordingly, the conventional bags 10 can be more generally referred to as inner containers 10, since they are typically at least partially contained by the reinforcing hollow bodies or reinforcing articles of this disclosure. The reinforcing hollow bodies of this disclosure may be more generally referred to as reinforcing articles (e.g., a bag-shaped reinforcing article 12 (FIGS. 1-3) and sleeve-shaped reinforcing articles 60 (FIGS. 6, 8, and 9). The reinforcing articles 12, 60 of this disclosure can be configured to at least partially protect the inner containers 10 from impacts, for example by providing impact (e.g., hoop) strength to the inner containers. For example, the reinforcing articles 12, 60 can be configured to reinforce at least a portion of the sidewall(s) 14 of the inner containers 10. Optionally, the reinforcing articles 12, 60 of this disclosure can also be configured to reinforce the bottom or bottom portions of the inner containers 10.

Advantageously, by using the reinforcing articles of this disclosure (e.g., sleeve-shaped reinforcing articles 60 (FIGS. 6, 8, and 9) and bag-shaped reinforcing articles (FIGS. 1-3)), the inner containers 10 may be formed from lower gauge materials than similar conventional flexible containers or bags. For example, the inner containers 10 may be formed from an about 4 gauge to about 9 gauge polymeric film, for example, about 5 gauge polymeric film (as compared with conventional 10-gauge film containers).

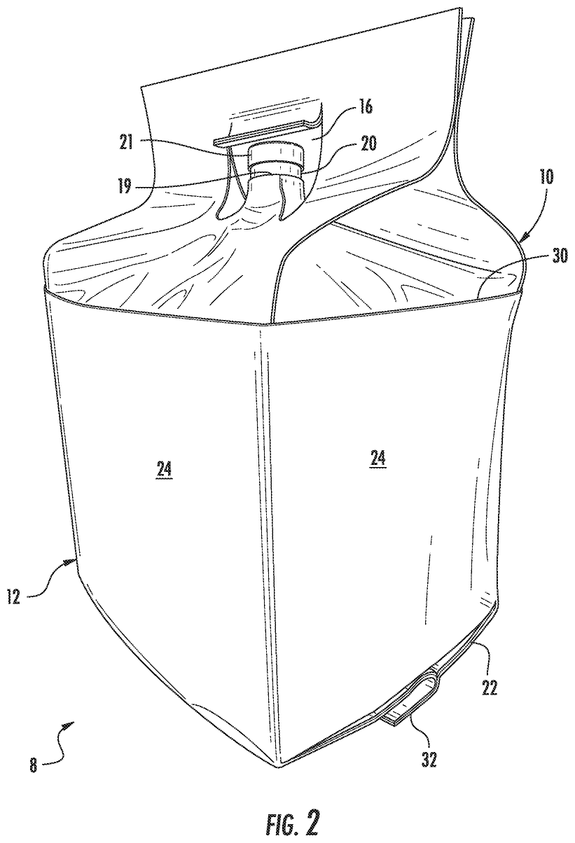

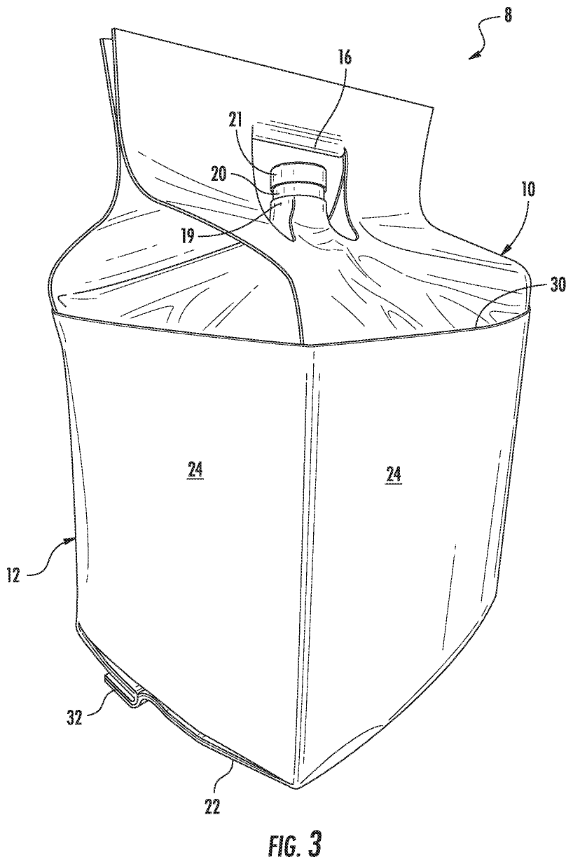

FIGS. 2 and 3 depict the substantially full inner bag or container 10 partially contained by, and reinforced by, the bag-shaped reinforcing article 12 of the first embodiment. The first embodiment reinforcing article 12 is configured to at least partially protect the inner container 10 from impacts, for example by providing at least impact (e.g., hoop) strength to the inner container 10. Referring to FIGS. 1-3, the first embodiment bag-shaped reinforcing article 12 includes a base wall 33 (e.g., base panel(s)) and one or more sidewalls 24 (e.g., side panels) extending upwardly from (e.g., upwardly from proximate) the periphery of the base 22, so that the reinforcing article sidewall(s) extend around an interior 26 (FIG. 1) of the reinforcing article. The interior or cavity 26 of the bag-shaped reinforcing article 12 is configured to at least partially contain the inner container 10. The lower end (e.g., base 22) and upper end opening 30 of the bag-shaped reinforcing article 12 can be spaced apart by a distance that is less than a distance between opposite upper and lower ends of the inner container 10. As a result, the upper portion of the inner container 10, upper handle 16, inner container opening 19, fitment 20 and/or cap 21 can extend outwardly through, or are otherwise positioned outwardly from, the upper opening 30 of the bag-shaped reinforcing article 12. Regarding the example depicted in FIGS. 1-3, the one or more sidewalls 24 of the reinforcing article 60 may be referred to as a tubular sleeve or sheath having at least one open end 62.

The bag-shaped reinforcing article 12 typically includes one or more seams for fixedly joining one or more of the walls (e.g., portions or panels) of the reinforcing article to one another. Depending upon the inclusion and/or placement of such seams, the demarcation between the respective walls (e.g., panels) of the reinforcing article may vary. In the example depicted in FIGS. 1-3, the base wall 22 of the reinforcing article 12 may be bisected by a seam 32, the transitions between the base 22 and the front and rear sidewalls 24 of the reinforcing article are not demarcated by a seam, and the transitions between the base and each of the right and left sidewalls 24 includes a triangular gusset 34 and a pair of triangular pleats 36. In the drawings, the pleats 36 are hidden from view, except that one of the pleats is schematically depicted by a dashed line in FIG. 1. For example, portions of the right and left sidewalls 24 can be tucked in prior to forming the seam 32, so that the reinforcing article 12 is gusseted bag (e.g., a bottom gusset bag and/or a side gusset bag). Alternatively, it is believed that the gussets 34 and pleats 36 may be omitted, so that the reinforcing article 12 is a flat bag.

The bag-shaped reinforcing article 12 may be formed in any suitable manner that will allow it to at least partially protect the inner containers 10 from impacts, for example by provide at least impact (e.g., hoop) strength to the inner container. For example, the at least one sidewall 24 of the bag-shaped reinforcing article can be configured to circumferentially engage, and circumferentially provide inwardly-oriented force against, an exterior surface of the substantially filled inner container 10 positioned in the cavity 26 (FIG. 1) of the reinforcing article.

In the first embodiment, the bag-shaped reinforcing article 12 can have an effective crosswise dimension or diameter defined by its sidewall(s) 24 that is approximately equal to, substantially equal to, or slightly smaller than the effective crosswise dimension or diameter defined by the side panel(s) or sidewall(s) 14 of the inner container 10. Accordingly, in one example of a method, the inner container 10 may be inserted into the cavity 26 defined by the bag-shaped reinforcing 10 article prior to filling the inner container with liquid. The inner container 10 may be placed inside the bag-shaped reinforcing article 12 while the inner container is in an at least partially empty, at least partially collapsed configuration, and then the inner container can be filled (e.g., substantially filled).

The bag-shaped reinforcing article 12 may be dimensioned so that the inner container 10 fits snuggly in the reinforcing article cavity 26 when the inner container is filled, so that the reinforcing article and inner container are retained in a fixed position relative to one another during transportation and use. For example, when the inner container 10 is substantially full of liquid, opposing face-to-face contact between at least the outer surface(s) of the inner container sidewall(s) 14 and the inner surface(s) of the reinforcing article sidewall(s) 24 may occur with sufficient force so that there can be a purposely tight fit (e.g., an interference fit) between the inner container sidewall(s) and the reinforcing article sidewall(s). The opposing face-to-face contact between the reinforcing article 12 and inner container 10 can extend annularly around the inner container 10 (e.g., circumferential engagement). The annular, opposing face-to-face contact (e.g., circumferential engagement) can extend along at least a portion of, or along all of (e.g., substantially all of), the length (e.g., height) of the bag-shaped reinforcing article 12.

In the first embodiment, the tensile strength of the flexible material of the bag-shaped reinforcing article 12 at least partially provides impact resistance for, and restricts (e.g., prevents) bursting of, an at least partially liquid-filled inner container 10 that may be dropped or otherwise be subject to bursting. For example, hoop stress in the inner container sidewall(s) 14 can be resisted (e.g., reduced) due to the tensile strength of the bag-shaped reinforcing article 12 and the circumferential engagement between the one or more sidewalls 14 of the inner container 10 and the one or more sidewalls 24 of the reinforcing article 12. In this regard, the bag-shaped reinforcing article 12 may be formed from at least one piece of various flexible materials having sufficient tensile strength to resist the hoop stress. In one example, the bag-shaped reinforcing article 12 may be formed from a high yield strength material, i.e., a material that has a minimum tensile strength at yield of at least about 5000 g/inch, preferably at least about 10,000 g/inch, as measured by ASTM D882. The material of the reinforcing article 12 may have a tensile peak value of at least 5000 g/inch, and preferably more than 20,000 g/inch, as measured by ASTM D882. The material of the reinforcing article 12 may have a tensile elongation of less than about 30%, and preferably less than about 15%, as measured by ASTM D882. In addition to or alternatively to resisting the hoop stress, the bag-shaped reinforcing article 12 can be configured to reinforce the inner container 10 in other ways. For example, the material of the reinforcing article 12 may have a tear strength of at least about 2000 g, and preferably at least 3000 g, as measured by ASTM D689. As another example, the material of the reinforcing article 12 may have a thickness of from about 1 mil to about 10 mil, as measured by ASTM F2251.

Referring to FIG. 4 regarding a first version of the first embodiment, the bag-shaped reinforcing article 12 may be formed from, or include, cross-laminated, mono-oriented polymer films 40, 42. FIG. 4 is an exploded view of a representative portion of cross-laminated, mono-oriented polymer films 40, 42 that are connected to one another by adhesive material 44. In FIG. 4, the molecular orientation of the films 40, 42 is schematically identified by double ended arrows 40A, 42A, wherein the molecular orientations of the films extend crosswise to one another, for example perpendicular to one another. By cross-laminating the oriented films 40, 42, the yield strength of the laminated structure can be higher in both the machine and cross-machine directions, as compared with the individual mono-oriented polymer films. The cross-laminated films 40, 42 may comprise polyethylene and/or any other suitable material or combinations thereof. For example, the cross-laminated films 40, 42 may contain recycled material, for example, recycled plastic shopping bags, recycled high density polyethylene bottles, or the like. Alternatively or additionally, the material of the reinforcing article 12 can comprise other suitable polyolefin-based materials.

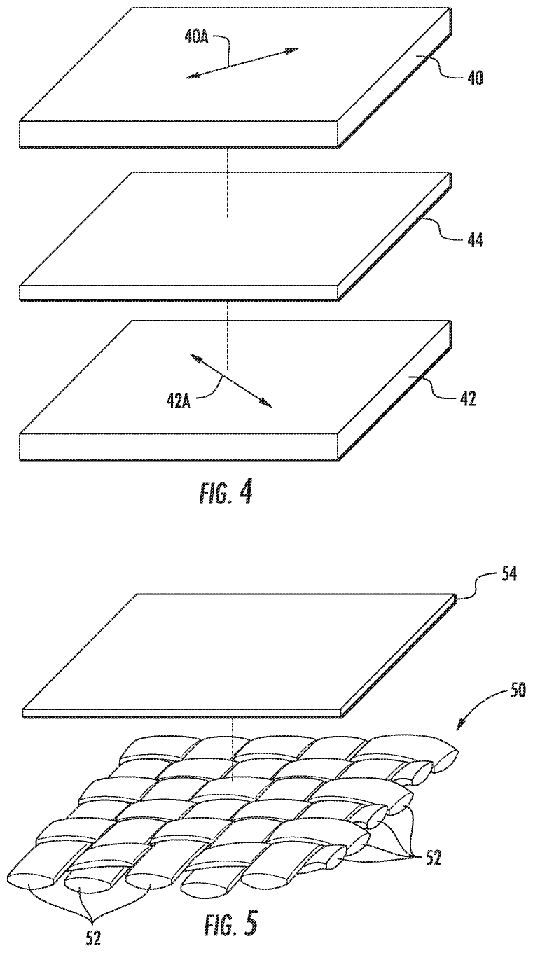

Referring to FIG. 5, in a second version of the first embodiment, the bag-shaped reinforcing article 12 may be formed from, or at least comprise, a woven material 50. The woven material 50 may comprise natural and/or synthetic materials. In one example, the bag-shaped reinforcing article 12 may be formed from a fabric 50, for example a woven fabric comprising, consisting essentially of, or consisting of crosswise woven polymer strips 52 (e.g., ribbons or tapes). More generally, the fabric 50 may be formed of other suitable materials, for example fibers, strands, filaments, yarns, threads, and/or other suitable materials that may be woven together and/or otherwise suitably assembled to at least partially form the fabric.

With continued reference to FIG. 5, the woven fabric 50 may be a substrate that is part of a laminate, or the like, wherein the woven material 50 or any other suitable layer of the laminate may be coated with a printable outer layer 54. The printable outer layer 54 can be a polymeric coating that forms at least a portion of an exterior surface of the bag-shaped reinforcing article 12 of the second version of the first embodiment. By way of printing on, or otherwise associating markings with, the printable outer layer 54, the bag-shaped reinforcing article 12 can also be used as an article for providing product/brand information, product instructions, or the like.

The woven polymer strips 52 and/or the printable outer layer 54 may comprise, consist essentially of, or consist of polyester, polypropylene, polyethylene, and/or any other suitable material or combinations thereof. For example, the reinforcing article 12 may be made from a recycled material, for example, recycled plastic beverage bottles, recycled polyethylene bags, or the like. Alternatively or additionally, the material of the reinforcing article 12 can comprise other suitable polyolefin-based materials.

A second embodiment of this disclosure can be like the first embodiment, except for variations noted and variations that will be apparent to those of ordinary skill in the art. As best understood by comparing and contrasting between FIGS. 1-3 and FIG. 6, at least the base, or base wall 22 and associated features of the bag-shaped reinforcing article 12 may be omitted, so that the reinforcing article of the second embodiment can be in the form of a sleeve-shaped reinforcing article 60 (FIG. 6), or the like. The second embodiment reinforcing article, sleeve, or sheath 60 is configured to at least partially protect the inner containers 10 from impacts, for example by providing at least impact (e.g., hoop) strength to the inner container 10.

As depicted in FIG. 6 and in accordance with the second embodiment, opposite ends/end openings 62, 64 of the sleeve-shaped reinforcing article 60 (e.g., reinforcing sleeve or sheath) can be spaced apart by a distance that is less than a distance between opposite ends of the inner container 10, so that one or both of the opposite end sections of the substantially filled inner container extend outwardly through the respective end openings of the reinforcing article. For example, as shown in FIG. 6, positioned outwardly of the upper opening 62 are the upper handle 16, opening 19, fitment 20, and cap 21 of the inner container 10; and positioned outwardly of the lower opening 64 is the lower handle 18 of the inner container.

A variety of different distances between the opposite ends/end openings 62, 64 of the sleeve-shaped reinforcing article 60 are within the scope of this disclosure. Accordingly, a variety of different distances that one or both of the opposite end sections of the substantially filled inner container 10 extend outwardly through the respective end openings 62, 64 are within the scope of this disclosure.

As with the bag-shaped reinforcing article 12 (FIGS. 1-3), the sleeve-shaped reinforcing article 60 (FIG. 6) can include one or more seams for fixedly joining one or more of the portions of the sleeve-shaped reinforcing article to one another. The seams can include any suitable adhesive materials and/or be formed by heat sealing thermoplastic material of the sleeve-shaped reinforcing article.

As an example, FIG. 7 depicts a precursor strip or sheet 66 of material from which the sleeve-shaped reinforcing article 60 can be formed. FIG. 8 depicts, for example, that opposite end margins of the precursor strip or sheet 66 can be joined to one another in the form of a fin seam or fin seal 70 that can extend into the interior space 71 defined by the sleeve-shaped reinforcing article 60 (e.g., reinforcing sleeve or sheath). The fin seal 70 can be pinched between a respective portion of the sleeve-shaped reinforcing article 60 and the inner container 10 in a manner that seeks to provide securing compressive force between the opposite end margins that are connected to one another by the fin seal 70. Regarding the example depicted in FIG. 8, the reinforcing article 60 may be referred to as a tubular sleeve or sheath having at least one open end, or more specifically a pair of opposite open ends 62, 64.

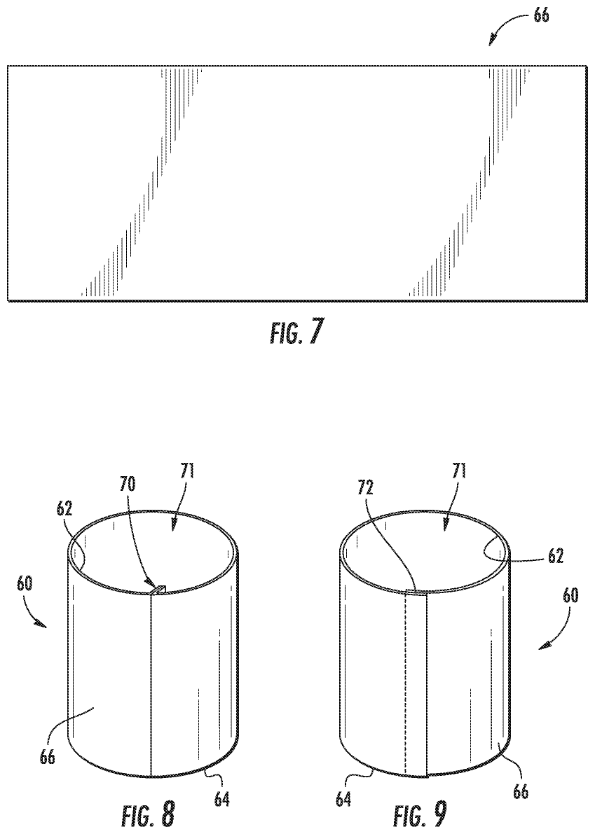

As another example, FIG. 9 schematically depicts that opposite end margins of the precursor strip or sheet 66 can be joined to one another in the form of an overlap seam or overlap seal 72 of the sleeve-shaped reinforcing article 60 (e.g., reinforcing sleeve or sheath). In one example, the overlap seam or seal 72 can be formed prior to inserting the unfilled inner container 10 into the cavity 74 that the sleeve-shaped reinforcing article 60 extends around/defines. Regarding the example depicted in FIG. 9, the reinforcing article 60 may be referred to as a tubular sleeve or sheath having at least one open end, or more specifically a pair of opposite open ends 62, 64.

In another example, the sleeve-shaped reinforcing article 60 can be formed around to the inner container 10 after the inner container is substantially filled, for example by forming the overlap seal or seam 72 after, or as part of, wrapping the precursor strip or sheet 66 around the inner container. For example, it is believed that the precursor 66 or sleeve-shaped reinforcing article 60 may be configured as a wrap-around component that is applied to the exterior of the inner bag or container 10 after the inner container is filled, for example, using adhesive material, adhesive strips, and/or other fasteners, or the like.

As further examples, two or more of the reinforcing articles 12, 60 may be nested together or otherwise associated with one another, so that an inner bag or container 10 can be simultaneously reinforced by multiple of the reinforcing articles.

In still other embodiments, it is believed that the bag-shaped reinforcing article 12, sleeve-shaped reinforcing article 60, or other suitable hollow body, reinforcing article or apparatus, or the like, may be integral (pre-attached or integrally formed) with the inner bag or container 10.

Reiterating from above, it is within the scope of this disclosure for one or more of the terms “substantially,” “about,” “approximately,” and/or the like, to qualify each of the adjectives and adverbs of the foregoing disclosure, for the purpose of providing a broad disclosure. As an example, it is believed that those of ordinary skill in the art will readily understand that, in different implementations of the features of this disclosure, reasonably different engineering tolerances, precision, and/or accuracy may be applicable and suitable for obtaining the desired result. Accordingly, it is believed that those of ordinary skill will readily understand usage herein of the terms such as “substantially,” “about,” “approximately,” and the like.

To supplement the present disclosure, this application incorporates entirely by reference U.S. Pat. Nos. 8,231,029, 8,348,509, 8,840,305, and 9,908,668.

In the above description and figures, examples of embodiments have been disclosed. The present invention is not limited to such exemplary embodiments. Unless otherwise noted, specific terms have been used in a generic and descriptive sense and not for purposes of limitation. The use of the term “and/or” includes any and all combinations of one or more of the associated listed items.

1. A package comprising:
a polymeric flexible bag comprising an interior space configured to contain liquid, and an opening to the interior space; and
a polymeric flexible reinforcing article configured to at least partially protect the flexible bag from impacts, the reinforcing article comprising a cavity at least partially containing the flexible bag, the reinforcing article comprising at least one piece of flexible polymeric material extending at least partially around the cavity, wherein:
the reinforcing article is configured to circumferentially engage, and circumferentially provide inwardly oriented force against, an exterior of the flexible bag,
opposite ends of the reinforcing article are spaced apart by a distance that is less than a distance between opposite ends of the flexible bag, and
an opening of the reinforcing article is positioned proximate one of the opposite ends of the reinforcing article and configured to have a portion of the flexible bag extend through the opening.

2. The package according to claim 1, comprising at least a fitment mounted to the opening of the flexible bag.

3. The package according to claim 1, wherein a portion of the flexible bag extends outwardly through the opening of the reinforcing article so that the opening of the flexible bag is positioned outside of the reinforcing article.

4. The package according to claim 3, wherein the portion of the flexible bag is an upper portion of the flexible bag that extends upwardly through the opening of the reinforcing article so that the opening of the flexible bag is positioned above the opening of the reinforcing article.

5. The package according to claim 1, wherein a portion of the flexible bag extends outwardly through the opening of the reinforcing article so that a handle of the flexible bag is positioned outside of the reinforcing article.

6. The package according to claim 5, wherein the portion of the flexible bag is an upper portion of the flexible bag that extends upwardly through the opening of the reinforcing article so that the handle of the flexible bag is positioned above the opening of the reinforcing article.

7. The package according to claim 5, wherein:
the opening of the reinforcing article is a first opening of the reinforcing article;
the portion of the flexible bag is a first end portion of the flexible bag;
a second end portion of the flexible bag extends outwardly through a second opening of the reinforcing article so that a second handle of the flexible bag is positioned outside of the reinforcing article; and
the reinforcing article is a sleeve.

8. The package according to claim 1, wherein the at least one piece of polymeric flexible material comprises woven fabric.

9. The package according to claim 8, wherein:
the woven fabric is a woven polymer substrate, and
the at least one piece of polymeric flexible material further comprises an outer polymeric coating supported by the substrate.

10. The package according to claim 1, wherein the at least one piece of polymeric flexible material comprises a polymeric laminate.

11. The package according to claim 10, wherein:
the laminate comprises first and second mono-oriented polymer films; and
in the laminate, the orientation of the first mono-oriented polymer film extends crosswise to the orientation of the second mono-oriented polymer film.

12. The package according to claim 1, wherein the reinforcing article is a bag.

13. A package comprising:
a polymeric flexible inner bag comprising an interior space configured to contain liquid, and an opening to the interior space; and
a polymeric flexible outer bag configured to at least partially protect the inner bag from impacts, the outer bag comprising a cavity at least partially containing the inner bag, and the outer bag being configured to circumferentially engage, and circumferentially provide inwardly oriented force against, an exterior of the inner bag, wherein
opposite ends of the outer bag are spaced apart by a distance that is less than a distance between opposite ends of the inner bag, and
an opening of the outer bag is positioned proximate one of the opposite ends of the outer bag and configured to have a portion of the inner bag extend through the opening.

14. The package according to claim 13, comprising a fitment mounted to the opening of the inner bag, wherein at least a portion of the fitment is positioned outside of the outer bag.

15. The package according to claim 13, wherein a portion of the inner bag extends outwardly through the opening of the outer bag so that the opening of the inner bag is positioned outside of the outer bag.

16. The package according to claim 15, wherein the portion of the inner bag is an upper portion of the inner bag that extends upwardly through the opening of the outer bag so that the opening of the inner bag is positioned above the opening of the outer bag.

17. The package according to claim 13, wherein a portion of the inner bag extends outwardly through the opening of the outer bag so that a handle of the inner bag is positioned outside of the outer bag.

18. The package according to claim 17, wherein the portion of the inner bag is an upper portion of the inner bag that extends upwardly through the opening of the outer bag so that the handle of the inner bag is positioned above the opening of the outer bag.

19. A package comprising:
a polymeric flexible bag comprising an interior space configured to contain liquid, and an opening to the interior space; and
a polymeric flexible sleeve configured to at least partially protect the bag from impacts, the sleeve comprising a cavity at least partially containing the inner bag, and the sleeve being configured to circumferentially engage, and circumferentially provide inwardly oriented force against, an exterior of the bag, wherein
opposite ends of the sleeve are spaced apart by a distance that is less than a distance between opposite ends of the bag, and
opposite openings of the sleeve are respectively positioned proximate the opposite ends of the sleeve and configured to have respective portions of the bag extend therethrough.

20. The package according to claim 19, wherein:
the opposite openings of the sleeve are opposite first and second end openings of the sleeve;
a first end portion of the bag extends outwardly through the first end opening of the sleeve and includes a handle and the opening to the interior space of the bag; and
a second end portion of the bag extends outwardly through the second end opening of the sleeve and includes a handle.
